(19) United States
(12) Patent Application Publication
(10) Pub. No.: US 2004/0243453 A1
(43) Pub. Date: Dec. 2, 2004

(54) Method, system, and storage medium for gathering, developing, and disseminating announcement and offering information in a collaborative network environment

(75) Inventors: J. R. Call, Northridge, CA (US); John M. Gardner, San Luis Obispo, CA (US); Mauro A. Gomes, Hopewell Junction, NY (US); Joseph M. Manz, Wappingers Falls, NY (US); Morten D. Petersen, Somers, NY (US)

Correspondence Address: Philmore H. Colburn II, CANTOR COLBURN LLP, 55 Griffin Road South, Bloomfield, CT, 06002, US

(73) Assignee: International Business Machines Corporation, Armonk, NY (US)

(21) Appl. No.: 10/449,334

(22) Filed: May 30, 2003

(51) Int. Cl. G06F 17/60

(52) U.S. Cl. 705/7

(57) ABSTRACT

An exemplary embodiment of the invention relates to a method, system, and storage medium for gathering, developing, and disseminating announcement and offering information in a collaborative network environment. The method comprises gathering offering information during initial stages of the offering development cycle; collaboratively reviewing the offering information among individuals assigned to a pre-defined set of business roles; and disseminating final offering information to individuals assigned to a pre-defined set of business roles as a result of the collaborative review. The collaborative review is performed at a desired time period during the offering development cycle. Other embodiments include a system and a storage medium.

### BACKGROUND

This invention relates generally to product planning and marketing activities, and more particularly, the present invention relates to a method, system, and storage medium for gathering, developing, and disseminating announcement and offering information in a collaborative network to environment.

Current business practices for announcing the introduction of new products and services into the marketplace involve a variety of communication channels. Business organizations often use one or more of the following: websites, electronic subscriptions and related electronic media, television and radio broadcast media, as well as other known marketing channels. Not only are there a variety of methods to communicate the new offering, but the specific message or content of the announcement can vary considerably depending on the target audience. For example, an announcement provided to the organization's business partners may be tailored to the level of sophistication these partners possess such as industry-specific technical data or offering specifications, while an announcement to a generalized customer base may be drafted utilizing more simplistic terminology. Thus, the introduction of a single product or service into the marketplace may require that several customized announcements be prepared.

Product announcement and offering activities today, as well as other product planning and development activities for a typical business, generally consist of stand-alone, document based, and decentralized systems and processes involving labor-intensive and oftentimes redundant functions. This is, in part, due to disparate systems, data, and applications on the market which cater to the specific requirements of each of the various departments within an organization involved in the offering planning and development processes. For example, at a minimum, a single, mid-to-large business organization typically comprises a marketing department, a sales team, a manufacturing component, an executive or corporate department, and a service/repair division. Each department may be involved with one or more aspects of an offering during its planning and development period and the nature of their involvement differs from department to department. For example, a sales department is concerned with establishing and maintaining a customer base. A marketing department focuses on presenting or displaying the offering in a manner that generates demand for it. Manufacturing is concerned with quality control and meeting production deadlines. It is evident that these departments require unique, specialized systems and applications to perform their tasks.

The current solutions on the market today do not allow these departments to effectively communicate and facilitate the overall end-to-end processes from offering planning to lifecycle management. Accordingly, performing announcement and offering activities for a new product or service is likewise disconnected from the product's development cycles.

As a result, the processes associated with offering announcements is typically completed within a matter of days before an offering is released, as changes and delays in any portion of an offering's development cycle may affect the critical information provided in the announcement material.

What is needed, therefore, is a way to streamline and centralize the offering planning and development processes whereby announcements and offerings activities are integrated into the planning, development, and management processes and disseminated in a time-effective manner.

### SUMMARY

An exemplary embodiment of the invention relates to a method, system, and storage medium for gathering, developing, and disseminating announcement and offering information in a collaborative network environment. The method comprises gathering offering information during initial stages of the offering development cycle; collaboratively reviewing the offering information among individuals assigned to a pre-defined set of business roles; and disseminating final offering information to individuals assigned to a pre-defined set of business roles as a result of the collaborative review. The collaborative review is performed at a desired time period during the offering development cycle. Other embodiments include a system and a storage medium.

### BRIEF DESCRIPTION OF THE DRAWINGS

Referring now to the drawings wherein like elements are numbered alike in the several FIGURES:

FIG. 1 is a block diagram of a network system for implementing the announcement system in an exemplary embodiment;

FIG. 2 is a flowchart illustrating the process of implementing the announcement system during the market planning phase for an offering in an exemplary embodiment;

FIGS. 3A and 3B represent a flowchart illustrating the implementation of the announcement system during the concept phase for an offering in an exemplary embodiment;

FIGS. 4A-4D represent a flowchart illustrating the implementation of the announcement system during the planning phase of an offering in an exemplary embodiment;

FIG. 5 is a flowchart illustrating the implementation of the announcement system during the development phase of an offering in an exemplary embodiment;

FIGS. 6A-6C represent a flowchart illustrating the implementation of the announcement system during the qualification stage for an offering in an exemplary embodiment;

FIGS. 7A and 7B are flowcharts illustrating the implementation of the announcement system during the launch phase for an offering in an exemplary embodiment;

FIG. 8 is a flowchart illustrating the implementation of the announcement system during the life cycle management phase for an offering in an exemplary embodiment; and

FIG. 9 is a flowchart illustrating the implementation of the announcement system during a change management process in an exemplary embodiment.

### DESCRIPTION OF THE PREFERRED EMBODIMENT

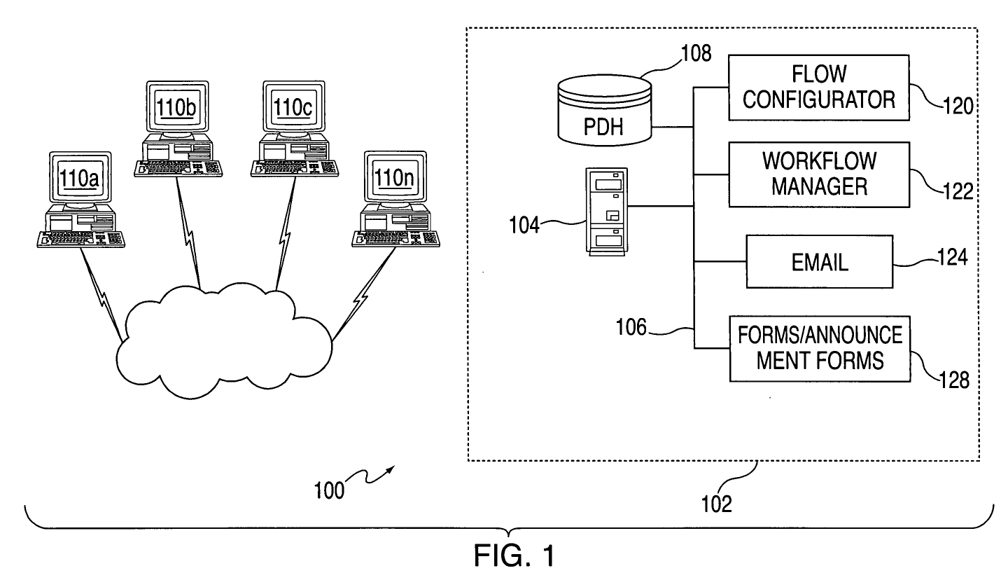

In an exemplary embodiment, the announcement system 102 is implemented via a networked system such as that depicted in FIG. 1. System 100 may be part of a wide area network including multiple geographical locations that are interconnected by high-speed data lines or radio links. In the simplified diagram of FIG. 1, system 100 represents a global business enterprise. The term “business enterprise” as used herein, refers to the organization implementing the announcement system 102. The announcement system 102 of system 100 comprises a user interface operating in a client/server architecture mode via a server 104, a network 106, a data repository 108, and a link to a variety of client systems 110a-110n.

Each of client systems 110a-110n may comprise a web-enabled personal computing device such as a desktop, laptop, or other similar apparatus known in the art. The term “client system” refers to any entity in communication with system 100. Client systems are operated by employees of the business enterprise, business partners, and customers.

Network 106 may comprise a LAN, a WAN, or other network configuration known in the art. Network 106 may include wireless technology, radio-based communications, telephony-based communications, or a combination of the above. For purposes of illustration, however, network 106 is a LAN Intranet. Access is limited to internal devices and applications through a firewall or similar security system (not shown) which protects system 100 from unauthorized access. The business enterprise preferably executes suitable multi-platform supported server software for creating secure, interactive Internet, Intranet, and Extranet applications, and which allows information stored in server 104 to be managed and presented to end users such as client systems 110a-110n via business applications utilizing data management components (e.g., IBM's DB2™) as well as a presentation component (e.g., Lotus Domino™). System 100 executes the announcement system 102, among other applications via server 104, client systems 110a-110n, or a combination of the above. Server 104 allows the business enterprise of system 100 to maintain up-to-date information about the offering planning, development, marketing, sales, and related business activities in a near real-time environment through its replication features and web browsers. Server 104 shares information with client systems 110a-110n, storing the most current data for access by user systems.

Client systems 110a-110n may access server 104 via collaboration, application/data sharing, or standard web browsers (e.g. Lotus Notes™—compliant software, HTML based or Java enabled web applications, etc.) located on these client systems. Software may be Lotus Notes™ although it is not necessary in order to realize the advantages of the present invention.

Internal data storage of server 104 may comprise any form of mass storage device configured to read and write database type data maintained in a file store (e.g., a magnetic disk data storage device) and is logically addressable as a consolidated data source across a distributed environment such as system 100. The implementation of local and wide-area database management systems to achieve the functionality of the storage element will be readily understood by those skilled in the art.

Data repository 108 stores product information including translated versions of the offering information where applicable, marketing data, announcement forms and data, and other information for implementing the announcement system's 102 features and functions as described further herein. Data repository 108 is used throughout the announcement process to facilitate the collection, creation, notification, review and collaboration of the information. Additionally, data repository 108 sends offering information to all downstream systems and processes as defined in the announcement process.

It will be understood to those skilled in the art that server 104 and data repository 108 may comprise a single unit such as a mainframe computer or other high-speed processing system.

Announcement system 102 provides a mechanism for announcing offerings of the business enterprise. It streamlines the collection and distribution of offering information to provide a single and consistent message throughout all of the means the business enterprise uses to communicate to its customers, business partners and employees. The announcement system 102 further defines, develops and deploys an announcement process, a suite of applications supporting the process, and a unique way of operating to enable the announcement of offerings to occur at the speed of the Web. The time and effort needed to produce an announcement can be reduced, improving the quality of announcements and the consistency of the message content.

The suite of applications of announcement system 102 include a flow configurator 120, a workflow manager 122, an email application (not shown), an employee directory (not shown), and forms 128 including electronic templates.

Flow configurator 120 comprises an application that defines the announcement process for an announcement in accordance with the announcement type being processed. Announcement types (ATs) include New (AT1), Change (AT2), End-of-Life (AT3), and Other (AT4). Flow configurator 120 determines the actual steps needed to complete the selected announcement deliverables by creating a draft work breakdown structure related to the announcement project. Workflow manager 122 comprises an application that uses the work breakdown structure created by flow configurator 120 to track the steps for completing the announcement. The draft work breakdown structure created by flow configurator 120 can be adjusted to the needs of the announcement and the individual tasks can be manually altered and scheduled. An Offering Data Manager (ODM) at one of client systems 110a-110n can also add and delete roles. The ODM or Project Development Team leader has the ability to set the schedule as to when the data is required for the various phases when adapting the announcement project schedule. Once the schedule is complete, workflow manager 122 will schedule the activity, provide notification to the owner that the activity is ready to begin, and will provide an overall view of the status of the announcement (e.g., activities completed, activities not completed, and the time it took to complete the activities). Announcement forms 128 include business templates, data acquisition templates, and the set of announcement deliverables (e.g., announcement letter, sales manual page, business partner attachment, and fact sheet).

An offering, as used herein, is a generic term and includes consulting, intellectual property, software, hardware, services, training, financing, maintenance, or any combination of the above. The announcement system 102 supports three announcement scenarios and four announcement types. The first scenario is a global offering which is announced on the same date everywhere. The second scenario is a global offering which will be announced on different dates based upon the geography or country choice. The third scenario is a geography or country announcement that is announced on the same day or different dates in the applicable geographies and/or countries.

As indicated above, the four announcement types used for classifying the announcement are New, Change, End-of-Life and Other. Other may be a Statement of Intent or a change to the business terms and conditions of an offering.

A variety of business roles are performed by individuals via announcement system 102 and client systems 110a-110n. These roles will now be described.

Executive entity. An executive entity refers to a decision-making body responsible for a market segment and preferably comprises representation from various business factions (e.g., development, marketing, services, customer service, production/fulfillment, finance, procurement, etc.). The executive entity establishes project development teams (PDTs) to manage each offering and sponsor announcements. Additionally, the executive entity also coordinates the activities of the PDTs to ensure that related announcements are synchronized and no conflicts occur between the offerings of other PDTs.

Project Development Team (PDT)

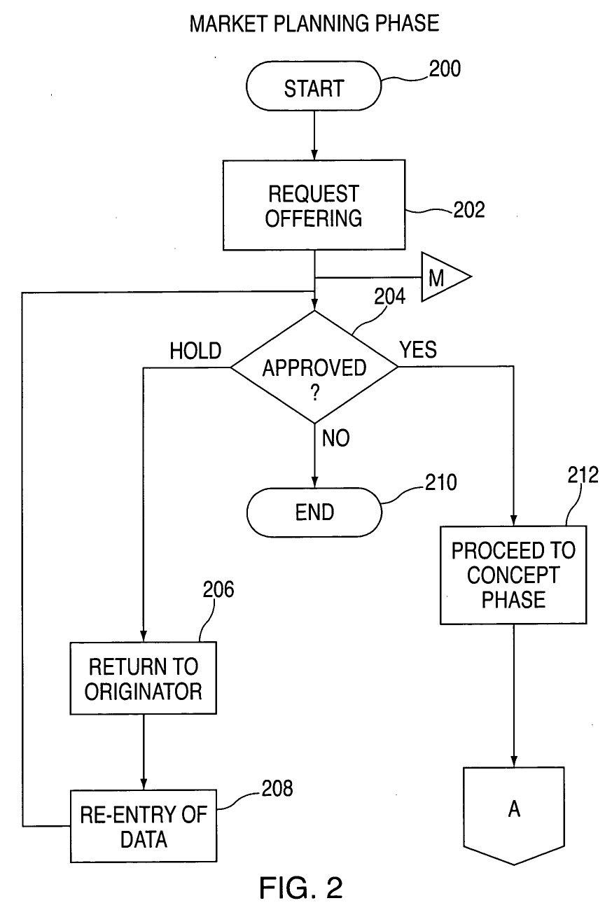

Representation on the PDT should include all relevant business factions (e.g., development, marketing, services, customer service and support, production/fulfillment, customer fulfillment, finance, pricing, procurement, etc.). The PDT is responsible for defining the offering, creating the development plan, driving the offering through all phases of the development process, including post general availability (GA) business performance and end-of-life, and making announcements about the offerings. The PDT interfaces formally with the executive entity via the decision checkpoints (described generally in FIGS. 2-9) to decide whether to continue to the next phase.

The executive entity and the PDT are closely linked, mutually supportive teams that, working together, embody project management. For example, the executive entity ensures that the PDT is sufficiently provisioned with resources, skills, dollars throughout the development cycle and provides support to eliminate or mitigate obstacles that may threaten the successful execution of their project.

As information is collected during the execution of the announcement process, the PDT reviews the input and makes decisions in the case of conflicting requirements.

Offering Data Manager (ODM)

The ODM functions as the project manager for an announcement and is overseen by the PDT leader. The ODM is responsible for performing setup activities for the project and offering, regularly monitoring the announcement, ensuring that all participants in the project are performing in accordance with the project plan, and resolving issues that may occur during the announcement process. These activities are described further herein.

Data Integrator (DI)

The Data Integrator is responsible for the definition of the offering structure as it relates to the characteristics of the offering (e.g., hardware, software, services, etc.). Examples of the type of information that the DI will provide include, but are not limited to: features, components, technical specifications, compatibility information, licensable entities, part or offering numbers, and the relationship among these, logical supplies, Bill of Material (BOM) information, etc. The DI interacts closely with the ODM on the details of the information and data needed for the announcement.

Life Cycle Management Team (LMT)

The Life Cycle Management team is an optional role that may become active as the offering is transferred to a life cycle team at General Availability or sometime thereafter depending on the stability of the offering. LMTs are implemented in cases where additional focus and expertise are required to manage the marketplace performance and ongoing end-of-life activities for the set of offerings in the market segment portfolio. The LMT is also accountable to the executive entity for the optimization of the business results across the entire portfolio. In those cases where an LMT is not established, the Project Development Team would typically manage the LMTs responsibilities.

When the offering is no longer profitable, or when new business direction governs that the offering should be withdrawn from marketing or discontinued from service, the LMT contacts the executive entity, and if acceptable, will execute the tasks dictated by the executive entity. These tasks include ensuring that the announcement system process is followed for that type of announcement so that the set of relevant customer-facing deliverables is created and that the required system updates are made in data repository 108 to facilitate changes in marketing communications and the downstream applications and processes.

Announcement Support Advisor (ASA)

The Announcement Support Advisor provides fulfillment and offering structure knowledge to the Project Development Team and announcement team members. The ASA is also responsible for ensuring that all fulfillment systems are loaded with the correct information on the day of announcement in order to support the fulfillment process.

Software Enablement Manager (SEM)

The SEM is responsible for ensuring that all software fulfillment systems, are loaded with the correct information on the day of announcement in order to support the fulfillment process. In addition, this role is responsible for enabling the manufacturing systems whenever physical manufacturing is applicable and to set up electronic delivery channels for the offering, when needed.

Contracts and Negotiations Planner (C&N)

The Contracts and Negotiations Planner is responsible for creating customer contract terms and conditions. When offerings are announced that require special contracts to be developed, the announcement system 102 process will link to the C&N process so that C&N can lead in establishing and reviewing the special terms and conditions for the offering.

Announcements using pre-defined and approved sets of Terms and Conditions do not require an interface with the C&N Planner.

Legal Representative (LGL)

The Legal representative will be involved when there are legal implications related to an announcement which need to be reviewed and assessed. A “Statement of Intent” is an example of an announcement where legal review is required. The reviews should be completed on a worldwide basis and involve legal representatives from other countries, as required and initiated by the legal representative for the overall announcement.

Some groups require that all their announcements are reviewed and approved by legal prior to announcement. The announcement system provides the flexibility for each PDT to involve the legal representative, as needed.

Worldwide Sales and Distribution Representative (S&D)

The geography marketing or sales and distribution functions are involved early in the process to provide the PDT with knowledge about market and business directions from the geographies or countries. This role includes the members from all geographies. The geography or country Sales and Distribution or Marketing teams may localize specific announcements, within the worldwide brand announcement strategy as defined by brand marketing, to meet the localized needs of the geography and country markets.

Pricer (PRC)

Pricing assumes a worldwide responsibility for creating and maintaining prices throughout the offering life cycle. Pricing participates in announcement system 102 process as the offering is being defined to ensure that the Project Development Team has the correct pricing structure, strategy and delegation rules available for input as part of the plan decision check point (DCP). Pricing, in many cases, may have several pricers assigned for different specialties within pricing (e.g., product, service, parts, etc.), with one person being assigned overall pricing responsibility for the offering and announcement. Prior to the announcement event, pricing will provide price information via a global pricing tool.

This role may cover both the worldwide brand pricers and the geography pricers. Where possible, the process design point is that all geography pricing will take place in parallel once the pricing strategy, structure and delegation rules have been established by the worldwide brand pricer. The country's pricing is the responsibility of the country, working in concert with worldwide pricing and the brand.

Global Announcements Representative (GAR)

The professional writers within the Global Announcements team will assume worldwide responsibility for editing, creating and producing the announcement system 102 set of customer-facing deliverables, excluding screens for websites. The GAR participates in the review and collaboration cycles in the new announcement process to ensure that the announcement communicates effectively for the intended audience. The GAR will provide professional editing of the “raw” offering information for data elements where editing is appropriate, prior to releasing it to a wider audience for their collaboration.

The GAR executes the production step of assembling the offering information collected in support of the announcement into the customer-facing deliverables. The GAR role, as represented in announcement system 102, may include a professional writer who assures that the material prepared communicates effectively for the intended audience, carries a consistent marketing message and terminology across all the deliverables for an offering, family or brand, and adheres to corporate policies and standards. The GAR role may also include a professional copywriter who reviews spelling, syntax, grammatical rules and word usage.

Marketing Representative (MKTG)

Based on an identified opportunity, marketing will create an offering business plan, brand marketing information, business case, or informal marketing information. This information is the basis for the product charter letter and creation of the PDT which is chartered to develop the offering through the concept phase decision check point. Marketing disciplines may include marketing management, market intelligence, integrated marketing communications, distribution channels management and technical support marketing.

Brand marketing is responsible for the strategy and the marketing plan of the offerings. They decide upon the specific announcement deliverables that will be produced, the relevant events, audiences, portals, and languages.

During the announcement process, marketing will be involved when selecting the offering and/or function names as well as the appropriate terms and conditions for the offering. Marketing will ensure that the input from all other marketing functions are included as part of the PDT assessments and participate in the final collaboration.

Service Delivery Planner (SDP)

The Service Delivery Planner provides input and reviews and collaborates with other roles as needed, on pertinent service related data elements, such as: dependency and enablement planning for service support; coordinating special service offerings associated with this base offering; putting parts in depots; and procuring parts.

These plans should take into account the worldwide plan, as well as plans for each geography and country where the offering will be marketed.

Integrated Marketing Communications Representative (IMC)

The Integrated Marketing Communications representative is responsible for preparing all content that is used in deliverables that carry a marketing message (often referred to as Sales Collateral). This includes arranging for localization and translation of sales collateral. These deliverables are customized to meet the needs of specific audiences and are built according to IMC processes by using IMC tools. In some groups, these responsibilities are carried out by a global brand manager as the leader with contributions from the various geography or country marketing leaders.

Global Financing Representative (GFR)

The global financing representative is involved in the announcement to develop customer financing plans and options and financing rates for the offering, if appropriate.

Distribution Channels Marketing (DCM)

This representative is involved during Market Planning to review and provide input to the marketing information. The DCM is responsible for the terms and conditions under which the business partners operate and collaborates with the marketing representative in the selection of the applicable business channels for the offering.

Configurator Developer (CD)

The configurator developer is responsible for ensuring that the offering can be configured on the day of announcement, in the various sales and manufacturing configurators available to the relevant audiences. The CD may be involved early in the review and collaboration cycles as they review the offering information, in particular the market approach, including the business template and data acquisition template, with the objective of identifying configurator development requirements. The CD receives configuration and compatibility information from development, during the announcement process. The announcement system 102 solution supports early population of offering information to support the testing of the configurators.

Market Influencers, Press, and Consultants (MI)

Where releasing announcement information to an authorized audience prior to the day of announcement is required, the announcement system 102 process supports the early release of announcement information to market influencers, the press, and consultants.

Business Partners (BP) are responsible for building their fulfillment, sales and support systems in support of the announcement based on using offering and announcement information from the announcement system 102 data repository 108. Business Partners (or vendors) can perform a role in the announcement process as a corporate employee or organization could, provided that the partner is qualified and the proper agreements have been reached with the PDT and the proper IT security is implemented.

Learning Services Representative (LS)

The announcement system 102 process ensures that LS are aware of upcoming announcement through their access to the data repository 108 and the notification process. During the announcement system 102 process, the Learning Services representative can prepare course material in support of the offering that is being announced.

Local Reader

Individuals, who are not part of the PDT but who have a business need to be informed about the planned announcement, may obtain access to the announcement system 102 solution through the use of the Local Reader role. The role is “view only” in that the role does not own any data for the offering or announcement. The Local Reader will be able to view the information in the data repository by using the defined set of reports and preview deliverables defined for the announcement system 102 solution. When an individual in a Local Reader role needs to comment on an aspect of the offering, he will provide his comments to individual assigned in an announcement system 102 role, by using a standard desktop or phone.

The product announcement system 102 is tailorable to meet the needs of various business units of the business enterprise. It provides a disciplined approach to ensure each step in the announcement process is completed correctly and on time. The system 102 also provides a single, authoritative source of announcement information readily accessible by authorized announcement participants. Further, the system 102 provides the ability to collect offering information as it is created during the development cycle.

A framework for the flow of information associated with the implementation of the product announcement system 102 is described in FIGS. 2-9. The product announcement system 102 begins the identification of an opportunity by Market Planning or a direct request for a new offering made by another enterprise group. The process ends with withdrawal from marketing and/or the discontinuance of service.

The product announcement system 102 also includes a feature that allows various measurements to take place throughout the process that measure the timeliness of completing the recommended steps in the announcement process and the acceptance of the announcement in the market. Measurement points are flagged throughout FIGS. 2-9 and are indicated with the letter ‘M’ inside a triangle or flag shape.

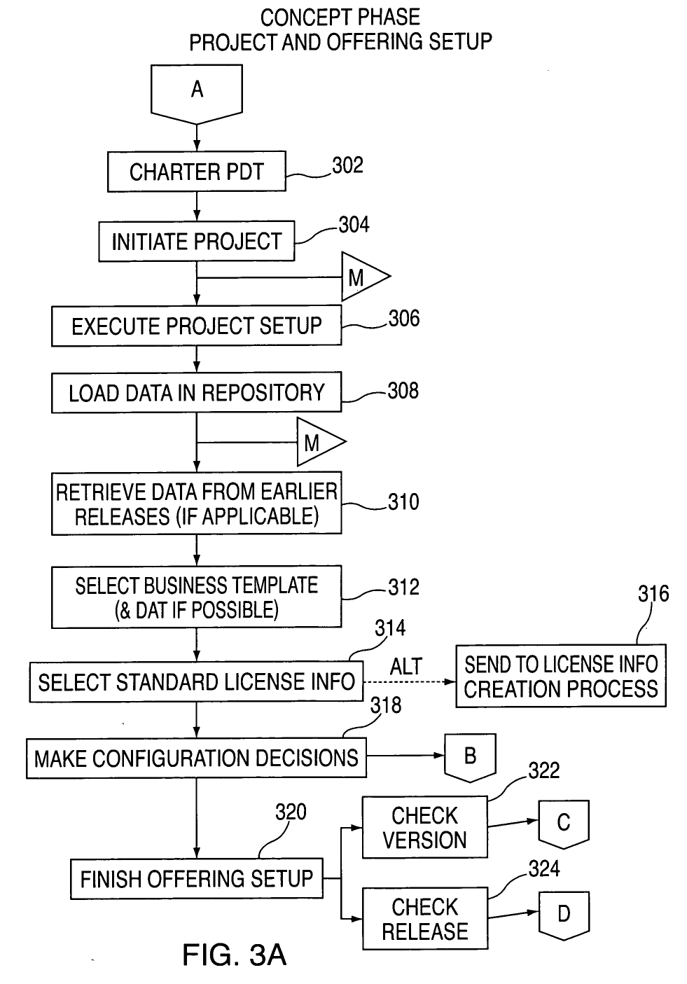

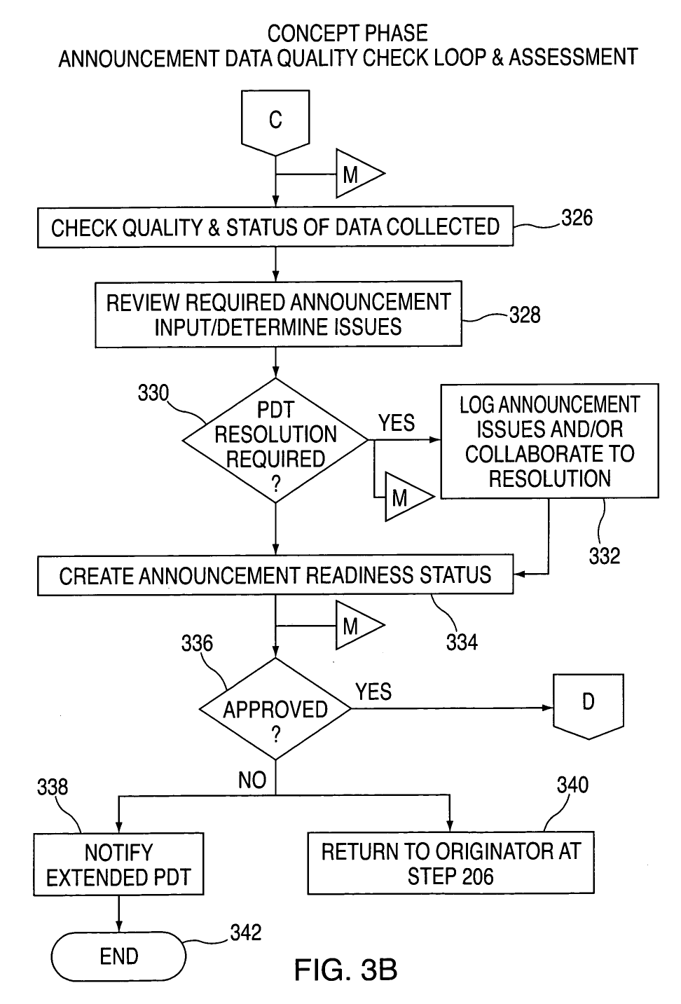

The process begins at step 200 of FIG. 2 where a request for an offering is received by an executive decision making entity (also referred to as executive entity) at step 202. At step 204, the executive entity determines whether to approve the request. This checkpoint of step 204 ensures that the offering does not conflict with other existing offerings. If there is a conflict noted that can be resolved, the request is returned to the originator at step 206 and the request data is re-entered accordingly at step 208. If there is a conflict at checkpoint 204 that cannot be resolved, the request for an offering is denied by the executive entity at step 210. Conversely, if there are no conflicts noted, the process continues to the concept phase at step 212. Alternatively, a request for offering may begin during the concept phase rather than the market planning phase in which case, steps 200-210 would be performed before step 302 of FIG. 3A.

During the concept phase, various data elements are gathered and reviewed by the Project Development team (PDT). Offering information data is collected and managed as individual data elements and aggregated sets of data elements via announcement system 102. Throughout the process, data states are assigned to the individual data element or fragment which expresses the reliability of the data. Data states include “draft”, “ready for review”, and “final”. The concept phase includes an announcement project and an offering project setup component as described in FIGS. 3A and 3B.

A project development team (PDT) is chartered at step 302 by the executive entity at client system 118. The charter defines the nature and scope of the announcement. The charter also approves the creation of a PDT team and Offering Data Manager. The Offering Data Manager (ODM) performs a leadership role in the management of the announcement process as described further herein.

The project is initiated at step 304. This step applies to offerings of announcement types 1, 2, or 4.

Project setup occurs at step 306 and includes selecting data from a marketing workbench data repository to determine the availability of the information contained within the offering business plan or marketing communication plan. These deliverables are all created by the market planning process although information may also come from other sources as dictated by business need. By selecting this information, the ODM will have access to the information created by Market Planning (or other). When the appropriate deliverables have been selected, the content of these will be copied into the announcement system 102 data repository 108. If the data is incomplete or not contained in the marketing workbench data repository, the ODM must enter this information into the announcement system 102 data repository 108 during the announcement process using the prescribed user interfaces. Project activities of step 306 also include classifying the announcement type in terms of the schedule and deliverables. The PDT members are also selected and roles are assigned. A subscription or notification service is created at step 306 as well. The information obtained and determined via steps 302-306 are loaded into data repository 108 at step 308 for later use as will be described further herein.

At step 310, the ODM performs offering setup functions where data from earlier releases may be retrieved if applicable. The product announcement system 102 permits an authorized person to select from a library of business templates or create a customized template. At step 312 a business template (BT) and Data acquisition template (DAT)(if applicable) is selected. Business templates define the valid options and combinations of options, which have verified fulfillment and manufacturing/distribution support, and are used to feed fulfillment systems. Data acquisition templates are structured representations of the valid business options as defined by the business templates. Data acquisition templates define the required part numbers, feature codes or other coding required to enable the business options in the fulfillment systems. If the ODM determines that any unique terms and conditions should apply for the announcement, they may be entered. The information provided is then transmitted to an external process for creating license information at step 316. This can be done via an HTML link where the business template and DAT information is stored in data repository 108 and retrievable by entities of the business organization who are assigned the role of processing these types of matters. If no unique terms and conditions apply, the ODM selects standard license information at step 314.

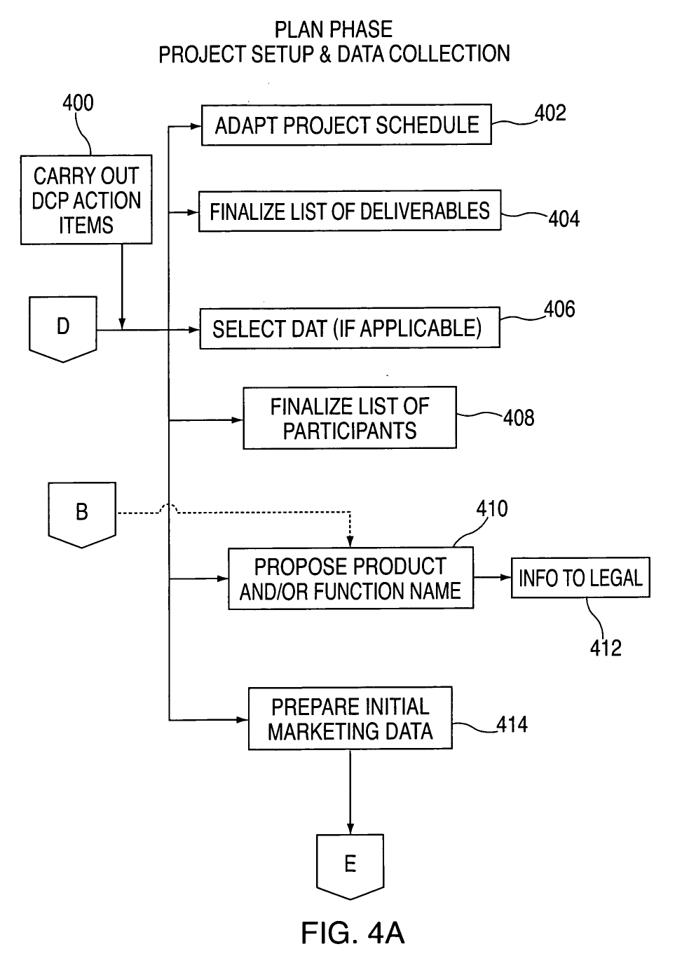

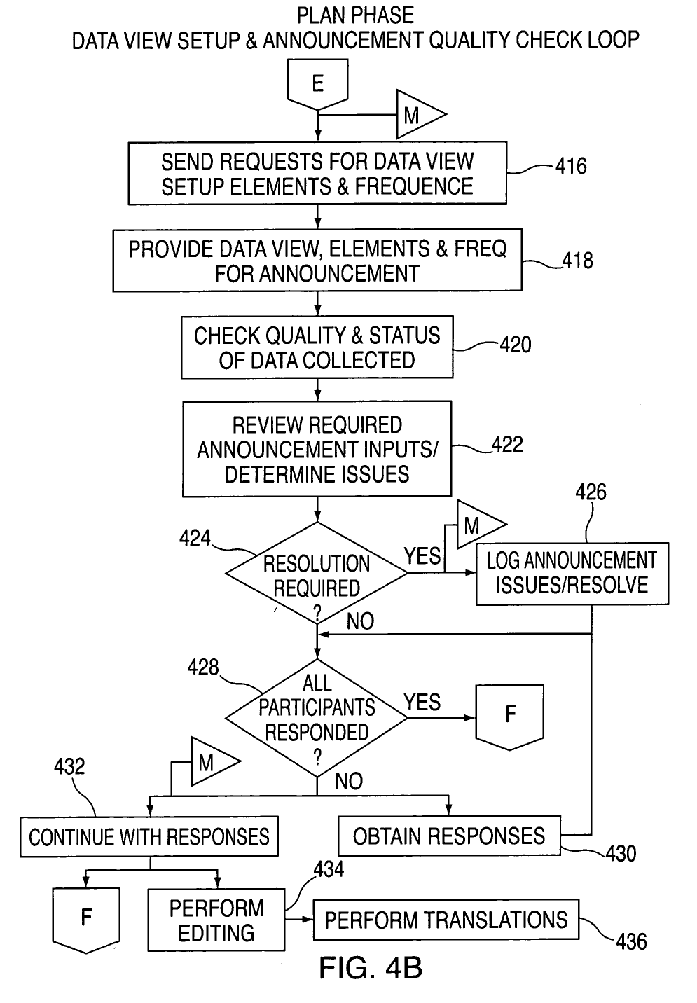

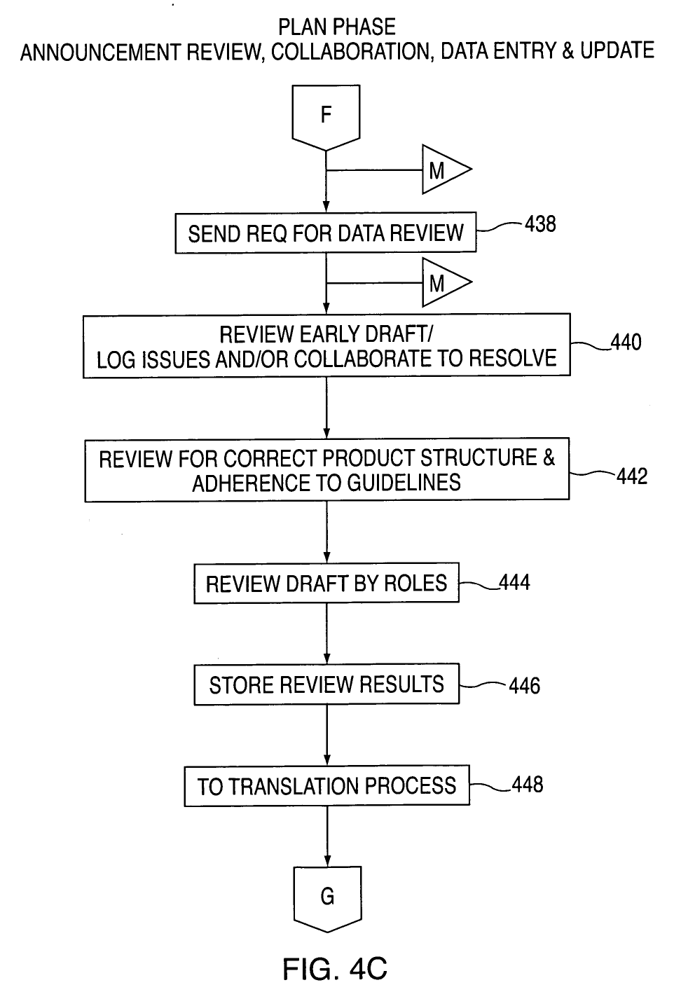

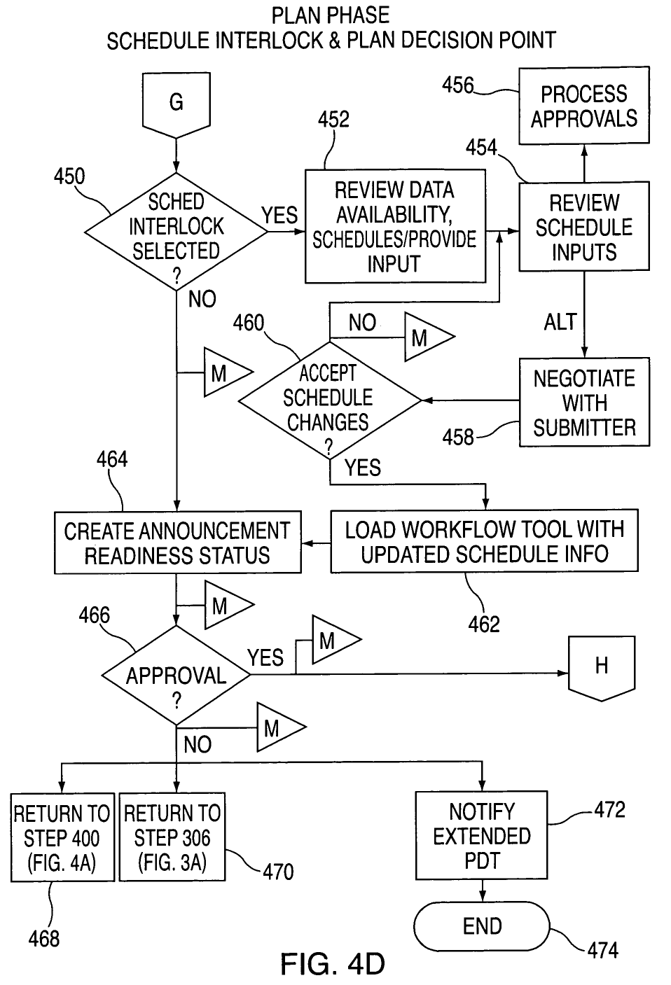

The process also involves making configuration decisions at step 318 and offering setup completion at step 320. Configuration decisions include selecting a project name, selecting a code name, selecting a Certificate Of Originality (COO), and indicating whether a schedule interlock is desired. One or more of the above configuration decision options may be selected by the user. Once a project name is selected, the process continues to the planning phase of FIG. 4A.

The remaining offering setup functions of step 320 include checking the version for the announcement type (AT) at step 322 whereby announcement project overview information is collected and the process then proceeds to the announcement data quality check loop of the concept phase described in FIG. 3B. Alternatively, the system 102 checks the release for the announcement type at step 324 and the process continues to the plan phase of FIG. 4A.

If the AT version is checked at step 322, the process continues in FIG. 3B at step 326 where the quality and status of the data collected is examined. The PDT reviews required announcement inputs and determines whether there are any outstanding issues that need to be resolved at step 328. If a resolution is required at step 330, the issues are noted and the ODM may collaborate with the PDT to resolve them at step 332. Once these issues are resolved, or alternatively, if there no issues were remaining, the process continues to the step 324 where an announcement readiness status is determined by the PDT. If the announcement is approved by the executive entity, the process continues to the planning phase of FIG. 4A. If the announcement is not approved at step 336, the executive entity notifies the extended PDT team of this fact at step 338 and the process ends at step 342. The executive entity also returns the announcement request and disapproval notification to the requester of the announcement at step 342. In this event, the process returns to step 206 of FIG. 2.

The planning phase begins with the announcement project setup and the offering data collection component of the announcement system 102 as described in FIG. 4A. Decision check point (DCP) action items are conducted by the ODM at step 400. At step 402, the ODM adopts an announcement project schedule. A list of deliverables is determined and finalized at step 404. If a DAT was not selected earlier in the concept phase, it may be selected at step 406. A finalized list of announcement project participants is selected by the ODM at step 408. An offering name is proposed at step 410 (if not determined earlier) and this information is sent to the legal department for review at step 412. This legal review may be an external process independent of the announcement system 102 which is accessible via interface features of system 102. Initial marketing campaign data or campaign plan may be prepared by the integrated marketing communications group at step 414 upon the completion of which the process continues to the data view setup and announcement quality check loop component of the planning phase of FIG. 4B. The marketing data comprises descriptive material and features for various audiences and portals. The planning phase continues in FIG. 4B whereby the ODM requests that data view, setup elements, and frequence activities be performed at step 416. The announcement system 102 provides a data view, setup elements and frequency for change notification relating to the announcement at step 418. These data view elements provide a means for various individuals assigned to selected business roles to review the data in a preliminary draft form. The data elements are stored in data repository 108 and managed as individual data elements as well as aggregated data elements for which allows flexibility to the offering setup and view processes. Each individual assigned to a business role selected for participating in the data view process performs a function that is designed in accordance with the nature of the business role. For example, a legal representative may review specific data elements for proprietary issues or possible legal conflicts. The selected individuals assigned to prescribed business roles check the quality and status of the data collected at step 420. The ODM reviews the responses and determines whether any issues remain at step 422. If there are issues that need to be resolved at step 424, the PDT logs the announcement issues and collaborates (if necessary) with the ODM to resolve them at step 426. If no resolution is required, the ODM checks to see if all participants have responded at step 428. If so, the process continues at step 438 of FIG. 4C. If any of the participants have not responded at step 428, the ODM may perform one of two options. The ODM can continue with the planning phase without pursuing the missing inputs at step 432 or may temporarily halt the planning process until the responses are all received at step 430. If the ODM waits for the missing responses, the process reverts to step 428 after a time period. If the ODM continues with the planning phase without the responses, the updated/reviewed information is then transmitted to an external process or entity for professional editing at step 434. Translations of the announcement information are performed at step 436 if the announcements are targeted for foreign customers. The planning phase continues in FIG. 4C where the announcement draft is reviewed, edited, and updated. At step 438, a request for data review is sent by the ODM via workflow manager 122. Various roles are charged with reviewing the announcement draft, logging issues, and collaborating with PDT members to resolve them at step 440. An individual assigned to a selected business role reviews the draft for correct product structure and adherence to enterprise guidelines at step 442. Other business roles may also be selected to review the draft at step 444. The results of the review are stored in data repository 108 at step 446. These results are then transmitted to the translation process at step 448 and the process proceeds to the schedule interlock component of FIG. 4D.

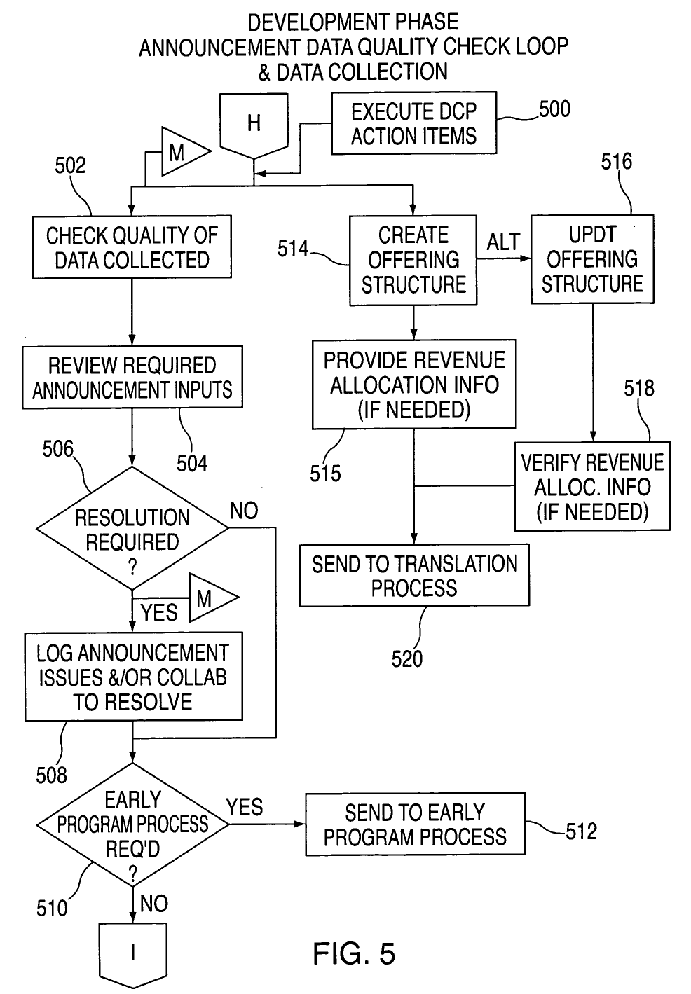

The schedule interlock component begins at step 450 where the system 102 checks to see if an announcement schedule interlock has been selected by the ODM at step 450. If so, an individual assigned to a selected business role reviews the data availability and schedules and provides input at step 452. The ODM reviews the announcement schedule inputs at step 454. The PDT may approve the announcement schedule at step 464 or alternatively may negotiate with the individual who submitted the schedule at step 458. If the PDT does not accept the schedule changes at step 460, the process returns to step 454 for a second review. If the changes are accepted at step 460, the workflow application 128 is loaded with the updated schedule information at step 462. Once the work flow tool has been loaded at step 462, or alternatively, if no schedule interlock has been selected at step 450, an announcement readiness status is created by the PDT at step 464. If the announcement is approved by the executive entity at step 466, the process continues to the development phase of FIG. 5. If the announcement is not approved at step 466, the process returns to either the plan phase (step 400) of FIG. 4A at step 468 or to the concept phase (step 306) of FIG. 3A at step 470. Additionally, the PDT team is notified at step 472 and the planning phase process ends at step 474.

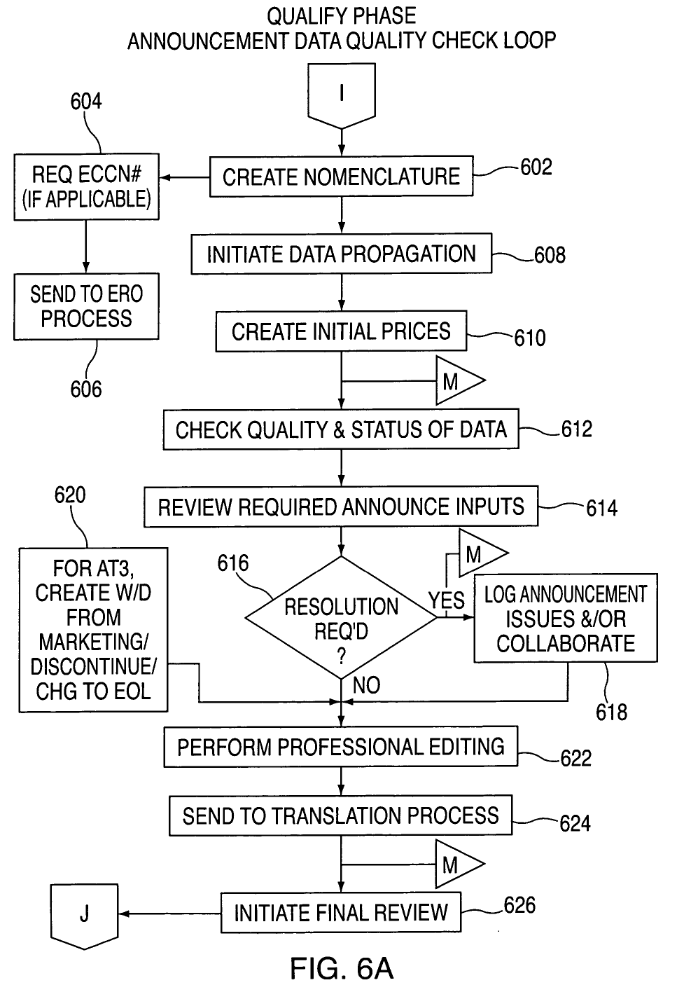

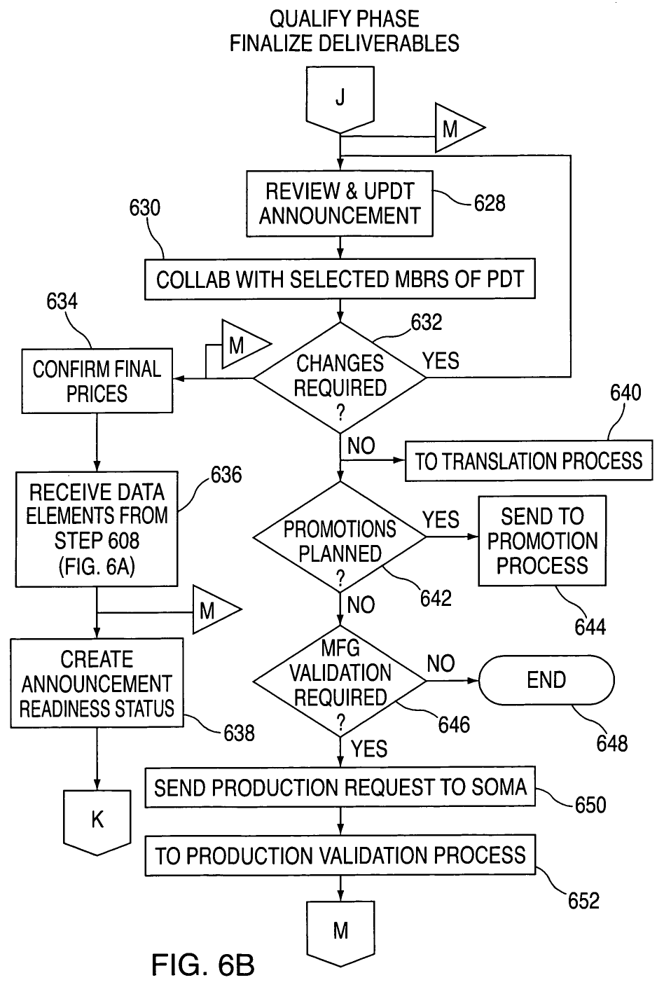

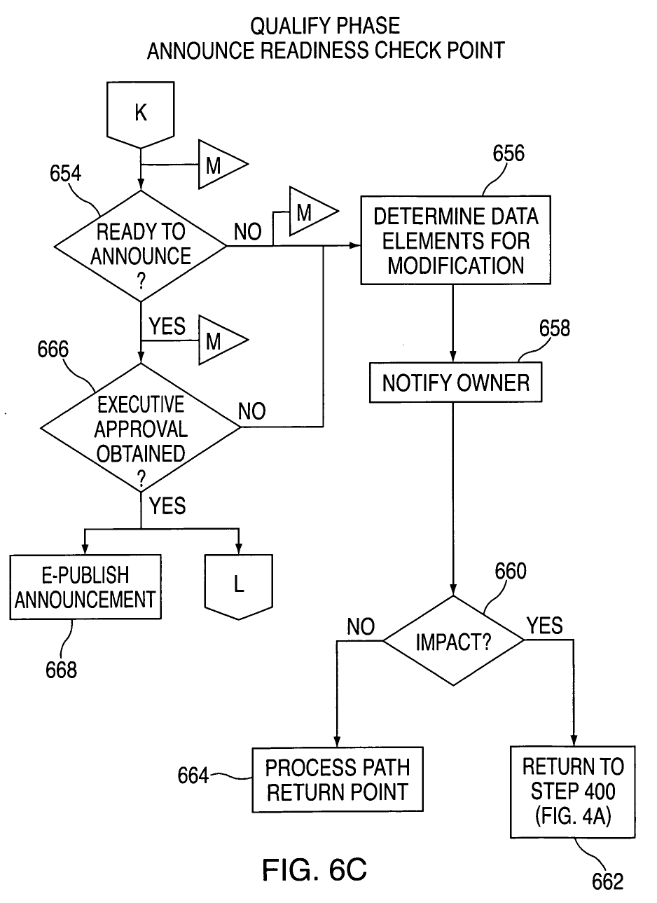

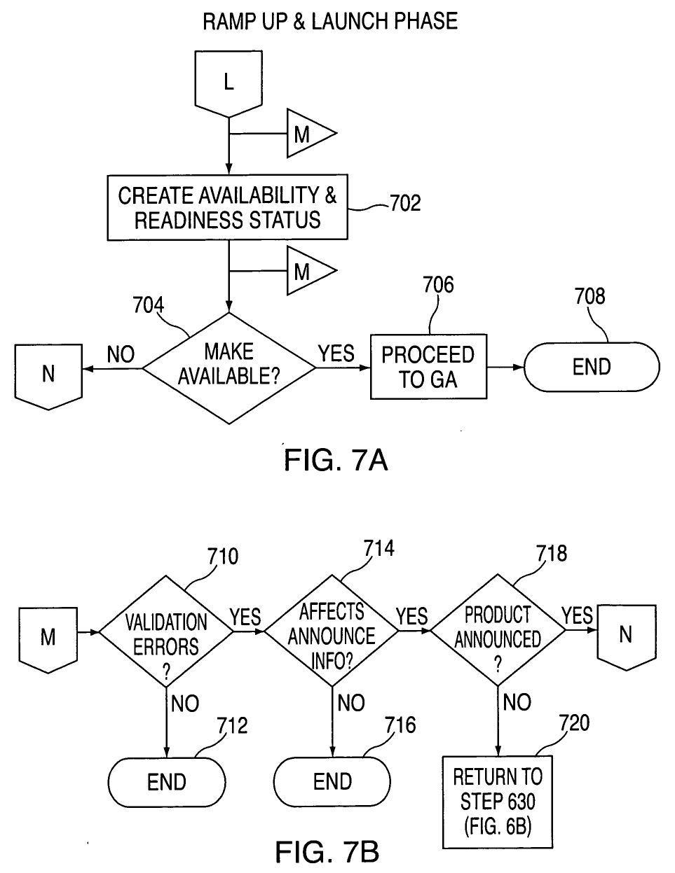

The process continues to the development phase of FIG. 5 where DCP action items are executed by the ODM at step 500. The announcement data quality check loop component of the development phase begins with a multi-threaded process as described herein. At step 502 the quality of data collected is reviewed. The announcement inputs are also reviewed at step 504 by the ODM to determine whether there are any outstanding issues. If there are issues that require resolution at step 506, the PDT logs the issues and may collaborate with the ODM to resolve them at step 508. If there are no issues or, alternatively, if they have been resolved, the system 102 determines whether an early program process is required at step 510. If so, the announcement information is sent to an external process at step 512 via the announcement system 102. If no early program process is required at step 510, the process continues to the qualify phase of FIG. 6A. In addition to checking the quality of data at step 502, an offering structure may be created at step 514. Alternatively, an existing offering structure may be updated at step 516. If the offering structure is newly created, revenue allocation information is provided at step 515 and the information is sent to the translation process at step 520. If, in the alternative, the offering structure is updated at step 516, the revenue allocation information is verified if necessary at step 518 followed by transmitting the information to the translation process at step 520. The announcement system includes a feature that allows for additional review and collaboration. Thus, the review, collaboration, and data update process steps described in FIG. 4C may be repeated during the development phase of FIG. 5, if desired.

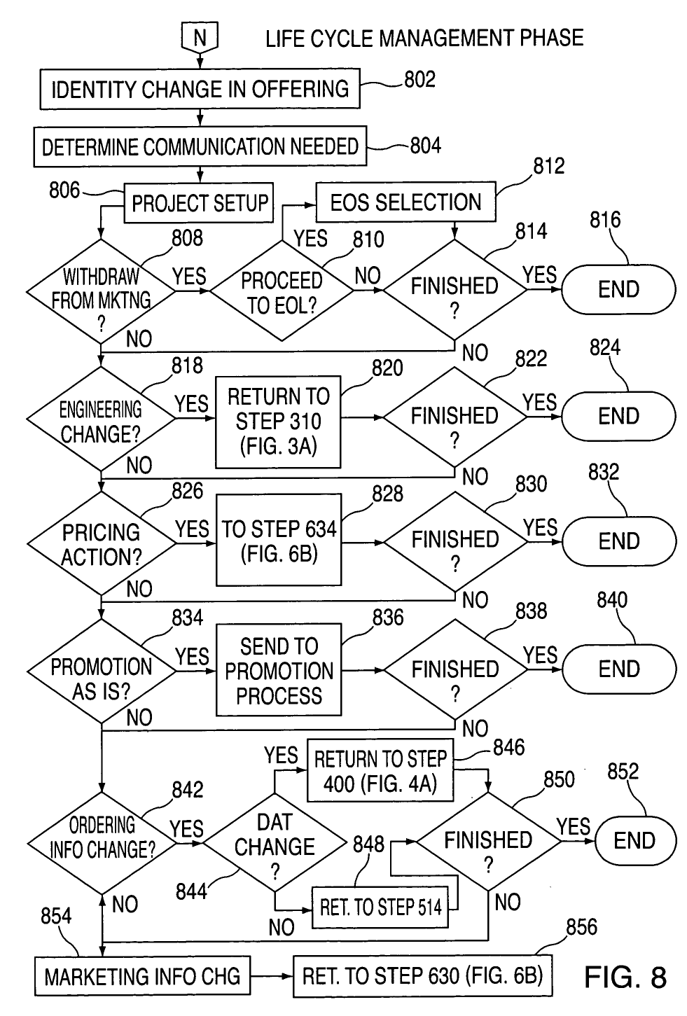

The qualify phase begins with an announcement data quality check loop as described in FIG. 6A. At step 602, an individual assigned to a selected business role creates a nomenclature. If applicable, an export classification control number (ECCN) is obtained at step 604 and the information is sent to an external export regulations office (ERO) process at step 606 which is accessible by the announcement system 102. The announcement system 102 initiates data propagation to various client systems 110a-110n for action at step 608. The pricer or similar representative creates initial prices at step 610. The ODM checks the quality and status of the data at step 612. The ODM reviews required announcement inputs at step 614. At step 616 it is determined whether there are any outstanding issues that need to be resolved. If so, the PDT logs announcement issues and/or collaborates with the ODM to resolution any issues at step 618. At step 622 professional editing is performed. Where the LMT has processed an End of Life announcement type (AT3), the ODM receives the announcement information from the LMT and forwards it to the professional editing process via the workflow manager 122 at step 620 (see generally FIG. 8). Once the professional editing is performed at step 622, the announcement draft is sent to the translation process at step 624 and a final review is initiated by the ODM at step 626. The process then continues in the qualify phase of FIG. 6B where deliverables are finalized. The announcement is reviewed and updated at step 628. The ODM collaborates with the PDT team at step 630. If changes are necessary at step 632, the process reverts to step 628 for a second review and update. If no changes are required, final pricing is confirmed by the PRC or similar entity at step 634 and data elements are received from the data propagation initiated at step 608 (FIG. 6A). An announcement readiness status is created at step 638 and the process continues to a readiness check point procedure described in FIG. 6C. If changes are required at step 632, the announcement information is sent to a translation process at step 640. It is then determined whether any sales promotions are planned at step 642. If so the information is sent to an external promotion process at step 644 for action. If no promotions are necessary, the system checks to see if a manufacturing validation is required for the announcement at step 646. If not, the qualification phase ends at step 648, otherwise, the production request is sent to a manufacturing representative for notification at step 650. From there, the information is forwarded to a validation process at step 652. The process then proceeds to the launch phase of FIG. 7. Subsequent to the creation of the announcement readiness status of step 638, the readiness check point of FIG. 6C is initiated. At step 654 it is determined whether the offering is ready to be announced. If so, the announcement system 102 checks to see if executive approval has been obtained at step 666. If so, the announcement is published electronically at step 668 and the process continues to the launch phase described in FIG. 7. At this point, the offering information becomes “final” (i.e., ready for final distribution among participants). If the executive approval has not been obtained at step 666, or alternatively, if the offering is ready for announcement at step 654, the data elements for modification are determined at step 656. The respective owner is notified at step 658. At step 660, the degree of impact is determined. If the impact is major, the process returns to step 400 of FIG. 4A at step 662. If the impact is minor, the process returns to one of the various preceding offering development stages as necessary depending upon the nature of the impact at step 664.

The ramp up and launch phase of the announcement system process is described in FIG. 7. An available and readiness status is created at step 702. At step 704, it is determined whether the product should be made available. If not, the process proceeds to the life cycle management phase described in FIG. 8. If the offering is to be made available at step 704, the process proceeds to General Availability (GA) at step 702 and the launch phase ends at step 708. Upon completion of the production validation process at step 652 of FIG. 6B, the system checks for validation errors at step 710. If there are no errors, the process ends at step 712. If there are errors detected at step 710, it is determined whether the errors affect the announcement information at step 714. If not, the process ends at step 716. If there is an affect at step 714, it is determined whether the product is to be announced at step 718. If so, the process proceeds to step 704. If not, the process returns to step 630 of FIG. 6B at step 720.

The life cycle management phase begins at step 802 where a change in an offering is requested. At step 804, the type of communication needed is determined. Project setup activities are executed at step 806. A series of queries follow. If the request is for a withdrawal from marketing or a discontinuance of service at step 808, the system checks to see if the withdrawal is due to and end-of-life decision at step 810. If yes, the end-of-service selection is made at step 812. If the withdrawal is not due to and end of life request, or alternatively, if the user is finished with the request at step 814, the process ends at step 816. If the user desires, he or she can select additional management activities.

At step 818, the user has the option of selecting an engineering change or revision. In this event, the process returns to step 310 of FIG. 3A. If the user has no addition changes to make at step 822, the process ends at step 824. If more changes are desired, the process continues at step 826. If the pricing action is desired, the process returns to step 634 of FIG. 6B at step 828. If the user has completed the selections at step 830, the process ends at step 832. If the user desires additional changes, the process continues to step 834 where it is determined if the promotion is ‘as is.’ If so, the requested change is transmitted to a promotion process external to the announcement system 102 but accessible to it at step 836. If the user is finished with the changes at step 838, the process ends at step 840. If not, the process proceeds to step 842.

At step 842, it is determined whether there are changes to be made to the ordering information. If so, the system determines whether the DAT is to be changed at step 844. If not, the process returns to step 514 of FIG. 5.

If DAT changes are to be made at step 844, the process returns to step 400 of FIG. 4A. In either event, the process continues at step 850 where it is determined whether there are further changes to be made. If not, the process ends at step 852. The remaining change possible for this phase is a marketing information change. If this option is selected at step 854, the process returns to step 630 of FIG. 6B at step 856.

The above described components and phases enable various entities of a business enterprise to collaborate on new offerings and offering change announcements in a seamless process via the announcement system 102. In addition, the system 102 allows change management activities that may occur in any of these phases to be implemented as well.

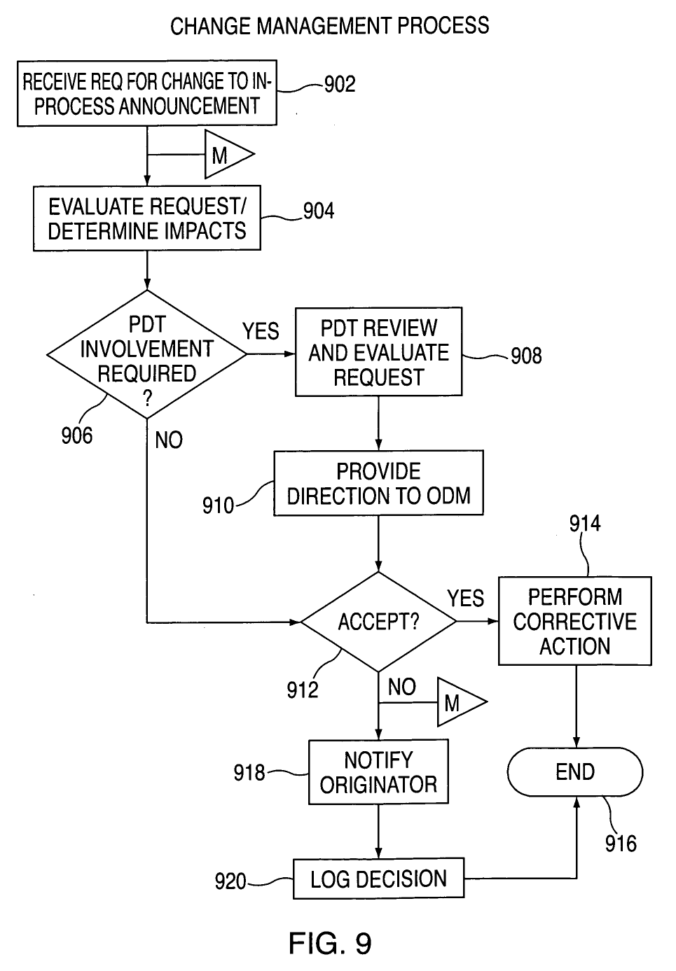

A sample change management process is described in FIG. 9. At step 902, a request for a change to an in-process announcement is received. The request is evaluated at step 904 to determine any impacts. At step 906, the ODM determines if the impacts defined warrant involvement by the PDT team. If so, the PDT team reviews and evaluates the request at step 908 and provides direction or guidance to the offering data manager at step 910. If the ODM accepts the requested change at step 912, or alternatively, if no PDT involvement is required at step 906, and the ODM accepts the request, any correction action necessary is performed at step 914 and the process ends at step 916. If the ODM does not accept the request at step 912, the originator of the request is notified at step 918, the decision is logged at step 920, and the process ends at step 916.

As described above, the present invention can be embodied in the form of computer-implemented processes and apparatuses for practicing those processes. The present invention can also be embodied in the form of computer program code containing instructions embodied in tangible media, such as floppy diskettes, CD-ROMS, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation.

1. A method for gathering, developing, and disseminating announcement and offering information throughout an offering development cycle via a collaborative network environment, the method comprising:
gathering offering information during initial stages of said offering development cycle;
collaboratively reviewing said offering information among individuals assigned to a pre-defined set of business roles; and
disseminating final offering information to individuals assigned to a pre-defined set of business roles as a result of said collaboratively reviewing said offering information;
wherein said collaboratively reviewing said offering information is performed at a desired time period during said offering development cycle.

2. The method of claim 1, further comprising:
refining said offering information among individuals assigned to a predefined set of business roles as a result of said collaboratively reviewing said offering information.

3. The method of claim 1, further comprising:
measuring timeliness of activities performed throughout said offering development cycle via a workflow management application.

4. The method of claim 1, further comprising:
evaluating activities performed throughout said offering development cycle via a decision checkpoint process wherein said individuals assigned to predefined business roles review said offering information and determine at least one of:
whether conflicts exist among existing offerings; and
whether to proceed with said offering.

5. The method of claim 1, wherein said final offering is disseminated for announcement to at least one of:
a sales group; and
a marketing group.

6. The method of claim 1, wherein said final offering information is disseminated to a supply chain group for input to a configuration and procurement application via at least one of a business template and a data acquisition template.

7. The method of claim 6, wherein said business template defines valid options and combinations of options with verified fulfillment and manufacturing support.

8. The method of claim 7, wherein said data acquisition template comprises structured representations of valid business options as defined by said business template; and wherein further said data acquisition template defines required part numbers and feature codes required to enable said business options in a fulfillment system.

9. The method of claim 1, wherein said business roles include at least one of:
an executive entity;
a project development team;
an offering data manager;
a data integrator;
a legal representative;
a marketing representative;
a sales representative;
a life cycle management representative;
a translations representative; and
a pricer.

10. The method of claim 1, wherein said offering information includes at least one of individual data elements and aggregated sets of data elements.

11. The method of claim 10, wherein said individual data elements and said aggregated sets of data elements are assigned data states, said data states indicating reliability of said elements, and wherein said reliability is defined by draft, ready for review, and final.

12. A storage medium comprising computer program code for gathering, developing, and disseminating announcement and offering information throughout an offering development cycle via a collaborative network environment, said storage medium including instructions for causing a computer to implement a method, comprising:
gathering offering information during initial stages of said offering development cycle;
providing said offering information to client systems operable for enabling individuals assigned to a pre-defined set of business roles at said client systems to collaboratively review said offering information; and
disseminating final offering information to individuals assigned to a pre-defined set of business roles as a result of said collaborative review of said offering information;
wherein said collaborative review of said offering information is performed at a desired time period during said offering development cycle.

13. The storage medium of claim 12, further comprising instructions for causing said computer to implement:
receiving refined offering information from individuals assigned to a predefined set of business roles as a result of said collaborative review of said offering information.

14. The storage medium of claim 12, further comprising instructions for causing said computer to implement:
measuring timeliness of activities performed throughout said offering development cycle via a workflow management application.

15. The storage medium of claim 12, further comprising instructions for causing said computer to implement:
implementing a decision check point process throughout said offering development cycle, wherein said individuals assigned to predefined business roles are prompted to review said offering information and determine at least one of:
whether conflicts exist among existing offerings; and
whether to proceed with said offering.

16. The storage medium of claim 12, wherein said final offering is disseminated for announcement to at least one of:
a sales group; and
a marketing group.

17. The storage medium of claim 12, wherein said final offering information is disseminated to a supply chain group for input to a configuration and procurement application via at least one of a business template and a data acquisition template.

18. The storage medium of claim 17, wherein said business template defines valid options and combinations of options with verified fulfillment and manufacturing support.

19. The storage medium of claim 18, wherein said data acquisition template comprises structured representations of valid business options as defined by said business template; and wherein further said data acquisition template defines required part numbers and feature codes required to enable said business options in a fulfillment system.

20. The storage medium of claim 12, wherein said business roles include at least one of:
an executive entity;
a project development team;
an offering data manager;
a data integrator;
a legal representative;
a marketing representative;
a sales representative;
a life cycle management representative;
a translations representative; and
a pricer.

21. The storage medium of claim 12, wherein said offering information includes at least one of individual data elements and aggregated sets of data elements.

22. The storage medium of claim 21, wherein said individual data elements and said aggregated sets of data elements are assigned data states, said data states indicating reliability of said elements, and wherein said reliability is defined by draft, ready for review, and final.

23. A system for gathering, developing, and disseminating announcement and offering information throughout an offering development cycle via a collaborative network environment, the system comprising:
a server;
a network in communication with said server;
a data repository in communication with said server;
announcement forms stored in said data repository;
a plurality of web-enabled client systems in communication with said server via said network;
an announcement system executed on said server, said announcement system comprising:
a user interface;
a workflow manager application;
a flow configurator application;
wherein said offering information is collected, developed, and disseminated throughout said development cycle via said announcement system.

24. The system of claim 23, further comprising:
business templates defining valid options and combinations of options with verified fulfillment and manufacturing support; and
data acquisition templates comprising structured representations of valid business options as defined by said business template, said data acquisition template defining required part numbers and feature codes required to enable said business options in a fulfillment system.

25. The system of claim 23, wherein said flow configurator application determines steps needed to complete an announcement by creating a draft work breakdown structure related to an announcement project.

26. The system of claim 25, wherein further said flow configurator defines an announcement process in accordance with a selected announcement type, said announcement type comprising at least one of:
a new announcement;
a change to an existing announcement;
an end-of-life announcement;
other, wherein other refers to a type of announcement that does not fall into any standard announcement types.

27. The system of claim 25, wherein said workflow manager application tracks steps for completing an announcement utilizing said draft work breakdown structure, and wherein further, said draft work breakdown structure:
is adjustable to the needs of said announcement; and
individual tasks are manually altered and scheduled.

28. The system of claim 23, wherein said offering information includes at least one of individual data elements and aggregated sets of data elements.

29. The system of claim 28, wherein said individual data elements and said aggregated sets of data elements are assigned data states, said data states indicating reliability of said elements, and wherein said reliability is defined by draft, ready for review, and final.
